(19) United States
(12) Patent Application Publication
(10) Pub. No.: US 2009/0202093 A1
(43) Pub. Date: Aug. 13, 2009

(54) Charging device for a hearing apparatus with a moveable charging contact and associated hearing device system

(75) Inventors: Axel Dannemann, Furth (DE); Roland Weigert, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL INSTRUMENTS PTE. LTD.

(21) Appl. No.: 12/322,983

(22) Filed: Feb. 10, 2009

(30) Foreign Application Priority Data
Feb. 12, 2008 (DE) 10 2008 008 670.3

(51) Int. Cl. H04R 25/00; H02J 7/00

(52) U.S. Cl. 381/323; 320/107

(57) ABSTRACT

A charging device for a hearing apparatus and a system which includes the charging device are provided. The charging device has at least one charging contact in order to charge the hearing apparatus. The charging contact is movable in order to align with a contact on a hearing apparatus contact thereby a standard charging device is be made available.

### CROSS REFERENCE TO RELATED APPLICATIONS

This application claims priority of German application No. 10 2008 008 670.3 filed Feb. 12, 2008, which is incorporated by reference herein in its entirety.

### FIELD OF INVENTION

The present invention relates to a charging device for a hearing apparatus, which has at least one hearing apparatus contact for transmitting electrical energy, with a charging contact, which can be connected to the hearing apparatus contact in order to charge the hearing apparatus. The term hearing apparatus is understood here to mean any sound-emitting device which can be worn on or in the ear, like for instance hearing device, a headset, earphones and suchlike. The invention also relates to a hearing device system, which includes a charging device and a hearing device.

### BACKGROUND OF INVENTION

Hearing devices are wearable hearing apparatuses which are used to assist the hard-of-hearing. In order to accommodate numerous individual requirements, various types of hearing devices are available such as behind-the-ear (BTE) hearing devices, hearing device with external receiver (RIC: receiver in the canal) and in-the-ear (ITE) hearing devices, for example also concha hearing devices or completely-in-the-canal (ITE, CIC) hearing devices. The hearing devices listed as examples are worn on the outer ear or in the auditory canal. Bone conduction hearing aids, implantable or vibrotactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted through a sound tube, which is affixed in the auditory canal by means of an otoplastic, to the device wearer's eardrum. Power for the hearing device and in particular for the signal processing unit 3 is supplied by means of a battery 5 which is also integrated in the hearing device housing 1.

### SUMMARY OF INVENTION

Hearing devices, in particular ITEs, are increasingly being equipped with rechargeable batteries and accumulators. It is then necessary to charge the hearing device when it is not being worn. By comparison with other charging methods, charging by way of galvanic contacts is advantageous in respect of the higher degree of efficiency. To this end, charging contacts are now to be provided on the surface of the hearing device. Since ITE hearing devices have an individually shaped hearing device shell, the contacting of the hearing device for the purpose of charging is often associated with difficulties, since the contacts of the charging device are to be connected accurately to those of the hearing device and are to be held in this position over a number of hours.

In this context, the patent specification EP 0630549 B1 discloses an apparatus for recharging the battery of an in-the-ear hearing device, which comprises a support having a seat for receiving the prosthesis. The seat corresponds exactly to the outer shape of the prosthesis which can be inserted therein. Two conductive terminals are also provided, which are connected to a source for electrical current and protrude from the wall of the support defining the seat. The disadvantage of this charging device is that it has to be individually produced for the hearing device wearer, since the contacts for each device in particular have to be individually determined as a result of the individual shell form. The ITE hearing device to be charged with such a charging device is disadvantageous in that the charging contacts rest directly against the skin when the hearing device is being worn.

DE 10 2005 061 795 A1 discloses a hearing device module, which includes an electromechanical interface for the mechanical and electrical coupling to a corresponding multipurpose interface of a hearing device.

DE 693 00 870 T2 also discloses an apparatus for recharging an accumulator of a hearing device, with the apparatus including a support with a seat which is embodied in accordance with the outer shape of the hearing device which can be inserted therein. The hearing device also includes conductive surfaces which can contact the contacts of the apparatus in order to charge the accumulator.

The object of the present invention consists in creating a charging device for a hearing apparatus and a hearing device system, which can be easily adjusted to individual positions of hearing apparatus contacts.

This object is achieved in accordance with the invention by a charging device for a hearing apparatus and a hearing device system with a hearing device and charging device, with the hearing apparatus including at least one hearing apparatus contact for transmitting electrical energy. The charging device includes a first charging contact, which is to be connected to the hearing apparatus contact in order to charge the hearing apparatus and a positioning facility on a carrier plate, with which the first charging contact can be moved to one of several positions on the carrier plate.

It is thus advantageously possible to provide a charging device which can be used universally for a plurality of hearing device wearers for instance and to adjust the charging contact(s) of the charging device specifically to the individual position of the hearing apparatus contacts with few hand movements.

The first charging contact is preferably a pin, which can be moved by the positioning facility at right angles to its longitudinal axis. Such a pin allows a certain distance to be bridged between a charging device wall and the hearing apparatus.

The first charging contact can also be moved in a plane in two directions by means of the positioning facility. This allows the charging contact to be positioned in any manner on a certain two-dimensional area.

The first charging contact including the positioning facility can also be arranged on a cover of the charging device. In this way, the hearing apparatus to be charged can be contacted when the cover is closed.

According to one development, the first charging contact can be moved on a charging surface of a metal contact of the charging device with the aid of the positioning facility and during the charging process, a charging current flows from the charging surface into the first charging contact. This free moveability of the charging contact on the metal contact of the charging device does not require a flexible line for the power supply to the charging contact.

The positioning facility can also include a first sliding element, which can be moved in one first direction and in which the first charging contact can be moved in a second direction at right angles to the first direction, as well as a second sliding element, which can be moved in the second direction and in which the first charging contact can be moved in the first direction. In this way the charging contact can be moved in a defined fashion in an x- and y-direction.

The positioning facility can also have two adjusting screws which are arranged at right angles to one another, with which the first charging contact can be moved in two orthogonal directions. Adjusting screws of this type are advantageous in that they simultaneously offer anchorage in the adjusting direction, if they are no longer rotated and/or are only rotated with difficulty.

According to a further preferred embodiment, the charging device has a second charging contact, which can likewise be moved with the positioning facility. In this way, all contacts which are needed to charge the hearing apparatus can be individually positioned or positioned together.

The inventive charging device can be used particularly advantageously in a hearing device system with an ITE hearing device. With this type of hearing device, the position of the hearing device and/or hearing apparatus contacts relative to the hearing device shell namely depends not only on the individual form of the hearing device shell but also on the position and orientation of the faceplate on the hearing device shell. However, the inventive charging device then allows the individual contact position to be quickly adjusted for the charging contacts of the charging device.

### BRIEF DESCRIPTION OF THE DRAWINGS

The present invention is now described with reference to the appended drawings, in which;

FIG. 1 shows a basic diagram of a hearing device according to the prior art;

FIG. 2 shows a cross-sectional view of an inventive charging device;

FIG. 3 shows a top view of the positioning facility;

FIG. 4 shows a side view of the positioning facility in FIG. 3 and

FIG. 5 shows an alternative embodiment of a positioning facility.

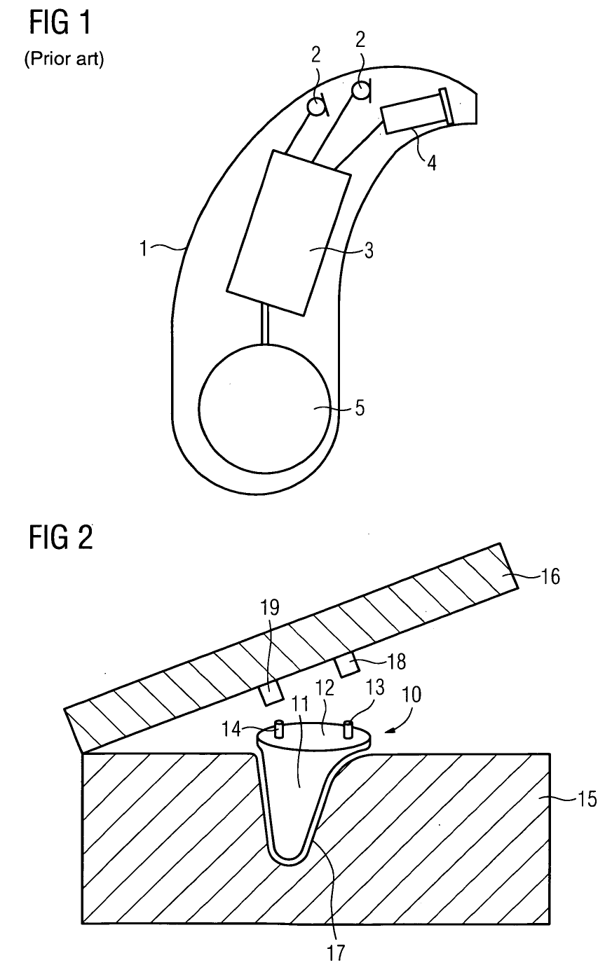

### DETAILED DESCRIPTION OF INVENTION

The exemplary embodiments illustrated in more detail below represent preferred embodiments of the present invention.

A cross-section of an exemplary embodiment of a charging device according to the present invention is shown in FIG. 2. It is used to charge an ITE hearing device 10. This ITE hearing device 10 has an individually manufactured ITE shell 11, which is sealed with a faceplate 12. Hearing device charging contacts 13, 14 are arranged on the faceplate 12. They are used to charge an accumulator inside the ITE hearing device 10. As the hearing device contacts 13, 14 which illustrate the afore-described hearing apparatus contacts are arranged on the faceplate 12, they do not contact the skin of the hearing device wearer when the ITE hearing device 10 is being worn.

The charging device itself consists of a bottom part 15 and a cover 16, with which the bottom part 15 can be sealed. A seat 17 is molded into the bottom part 15, said seat if necessary receiving the individually molded ITE shell 11 in an accurately fitting fashion. The seat 17 essentially determines the position of the hearing device contacts 13, 14 if the ITE hearing device 10 is inserted into the charging device for charging purposes. The position of the hearing device contacts 13, 14 is also influenced by the assembly position of the faceplate 12 on the ITE shell 11, but also by the faceplate 12 itself. The position of the hearing device contacts 13, 14 is thus always dependent on the manufacturing tolerances of the faceplate. Larger tolerances in respect of the rotational alignment of the faceplate 12 on the ITE shell 11 also exist. If the faceplate 12 is adhered to the ITE shell 11 in a manner so as to be rotational in respect of a standard position, the positions of the hearing device contacts 13 and 14 thus also change. It is then not possible to determine precisely from the outset the points upon which these two contacts 13 and 14 are actually arranged in each instance.

The aim is thus to be able to provide a standard charging device, with which the hearing apparatus and/or the hearing device can be reliably charged, despite this indeterminacy in terms of the positions of the hearing device contacts 13, 14. In accordance with the invention, the charging contacts 18, 19 are thus arranged so as to be displaceable in the cover 16 of the charging device. The position of these charging contacts 18, 19 is to be adjusted once for the individual hearing device and can then remain unchanged. When closing the cover 16, the charging contacts 18, 19 of the charging device then reliably contact the hearing device contacts 13, 14.

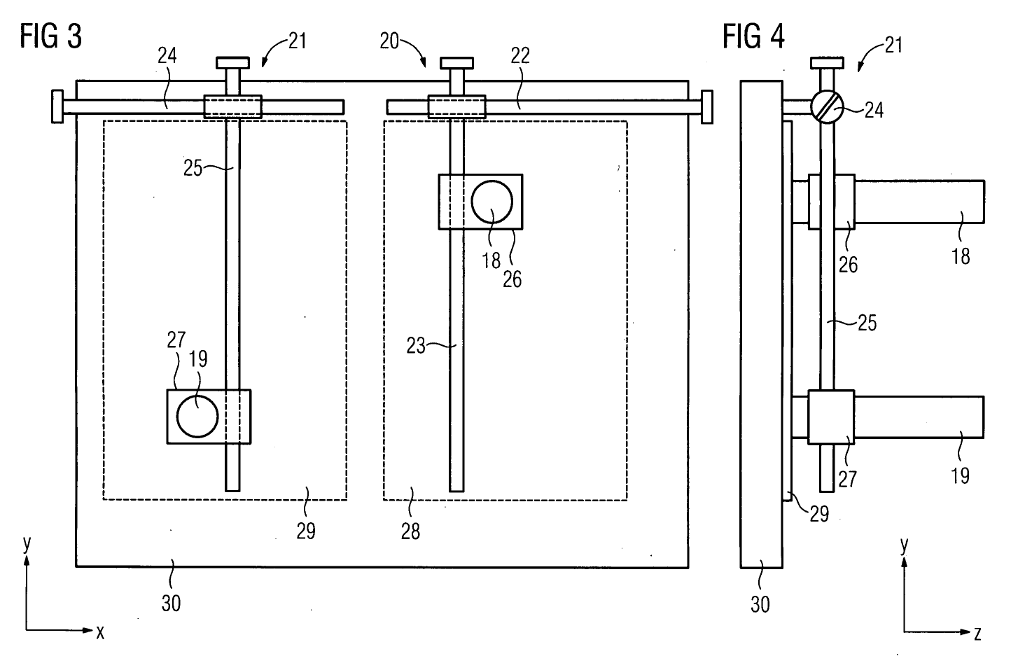

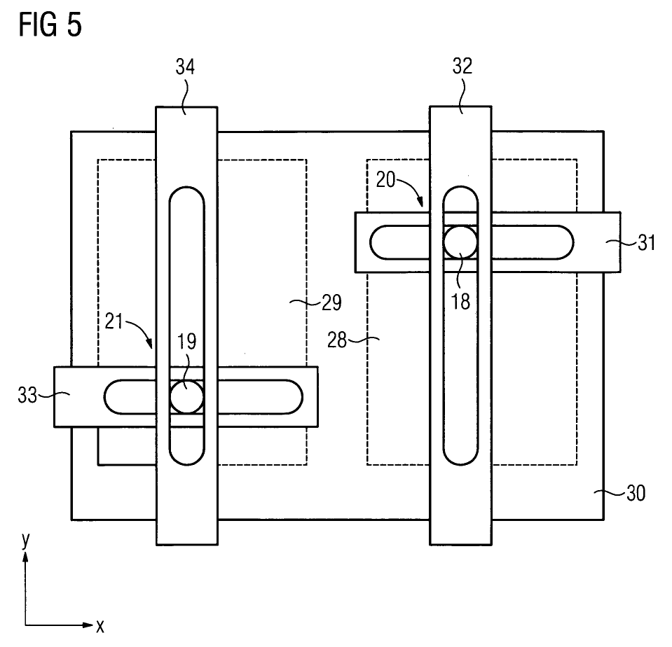

FIG. 3 shows a top view of a first exemplary embodiment of a positioning facility for the charging contacts 18 and 19. This positioning facility is integrated into the cover 16, which is not shown in FIG. 2 for the sake of clarity. It essentially consist of two positioning units 20 and 21, which can move and fix a corresponding charging contact 18, 19 in each instance Each positioning unit essentially consists of two adjusting screws 22, 23 and/or 24, 25 with which brackets 26 and 27 of the charging contacts 18 and 19 can be moved in the x- and y-direction in each instance. The charging contacts 18, 19 are preferably embodied as spring contacts (springy in respect of the z-direction). The side view in FIG. 4 shows how the charging contacts 18 and 19 are embodied here in the manner of a pin. Its free end is used in accordance with FIG. 2 to contact the hearing device contacts 13 and 14. The end facing the free end touches a respective charging and/or contact surface 28, 29. These contact surfaces 28, 29 are attached to a carrier plate 30, which can represent a wall of the cover 16 for instance. The contact surfaces 28, 29 thus represent the maximum adjusting region by means of the positioning units 20, 21.

During the charging process, electricity is introduced into the contact surface 28 for instance, is routed from there through the charging contact 18 to the hearing device contact 13 and is finally routed to the integrated accumulator in the ITE hearing device 10. The charging contacts 18 and 19 were previously moved to the individually required positions with the aid of the positioning units 20, 21. To ensure that the screws 22 to 25 no longer change following the adjustment, they can be fixed with an adhesive or other suitable means if necessary.

A top view of an alternative embodiment of a positioning facility is shown in FIG. 5. The two charging contacts 18, 19 are located here at the point of intersection of two orthogonally arranged guide rails 31, 32 and/or 33, 34 in each instance. Each guide rail has a long hole, in which the respective charging contact can move in a certain region. They thus likewise define the adjustment range of the charging contacts 18, 19 in the x- and y-direction. The adjustment ranges correspond here in turn to the contact surfaces 28, 29 on the carrier plate 30. In the desired position, the guide rails are prevented from moving. This can in turn take place using adhesive, pins, brackets or other suitable means. Two orthogonally arranged guide rails 31, 32, and/or 33, 34 again represent a positioning unit 20 and/or 21 in each instance.

If necessary it is sufficient for a charging device to only be equipped with a freely positionable charging contact. This may be the case for instance if one of the hearing device contacts is sufficiently large. The charging device may however also be equipped with more than two positioning units 20, 21, in order to produce additional contacts to the hearing device for signal transmissions for instance. In each case, it is possible for a standard charging device, the charging contact positions of which are not determined, also to be used to charge individually formed hearing apparatuses and/or hearing devices.

1-9. (canceled)

10. A charging device for a hearing apparatus, the hearing apparatus having a first hearing apparatus contact for the transmission of electrical energy, the charging device comprising:
a carrier plate;
a first charging contact for connecting to the first hearing apparatus contact in order to charge the hearing apparatus; and
a positioning facility arranged on the carrier plate and attached to the first charging contact such that the first charging contact is movable to one of a plurality of positions in order to align the first charging contact with the first hearing apparatus contact.

11. The charging device as claimed in claim 10, wherein the first charging contact is a pin which is movable by the positioning facility at right angles to a longitudinal axis of the first charging contact.

12. The charging device as claimed in claim 10, wherein the first charging contact is moveable in two planar directions by the positioning facility.

13. The charging device as claimed in claim 11, wherein the first charging contact is moveable in two planar directions by the positioning facility.

14. The charging device as claimed in claim 10, further comprising:
a cover,
wherein the first charging contact and the positioning facility are arranged on the cover.

15. The charging device as claimed in claim 10, further comprising:
a metal charging surface,
wherein the first charging contact is movable by the positioning facility on the metal charging surface, and
wherein during a charging process a charging current flows from the charging surface into the first charging contact.

16. The charging device as claimed in claim 10, wherein the positioning facility comprising:
a first sliding element movable in a first direction, and
a second sliding element movable in a second direction at a right angle to the first direction,
wherein the first charging contact is aligned to the first hearing apparatus contact by moving the sliding elements.

17. The charging device as claimed in claim 10, wherein the positioning facility comprising:
two adjusting screws arranged at a right angles to one another,
wherein the first charging contact is movable in a first direction and a second direction by the two adjusting screws, and
wherein the first and second directions are at right angles to one another.

18. The charging device as claimed in claim 10, further comprising:
a second charging contact for connecting to a second hearing apparatus contact in order to charge the hearing apparatus; and
wherein the positioning facility is further attached to the second charging contact such that the second charging contact is movable to one of a plurality of positions in order to align the second charging contact with the second hearing apparatus contact.

19. A charging device for a hearing apparatus, the hearing apparatus having a two hearing apparatus contacts for the transmission of electrical energy, the charging device comprising:
a carrier plate;
two charging contacts for connecting to the two hearing apparatus contacts in order to charge the hearing apparatus; and
a positioning facility arranged on the carrier plate and attached to each of the charging contacts such that each charging contact is movable to one of a plurality of positions in order to align the respective charging contact with one of the two hearing apparatus contacts,
wherein each charging contact is moveable in two directions by the positioning facility, and
wherein the two directions are a first direction and a second direction which are at right angles to one another.

20. The charging device as claimed in claim 19,
wherein each of the two charging contacts is a pin, and
wherein each of the two charging contacts is movable by the positioning facility at right angles to a longitudinal axis of the respective charging contact.

21. The charging device as claimed in claim 19, wherein the positioning facility comprising for each of the two charging contacts:
a first sliding element movable in the first direction, and
a second sliding element movable in the second direction,
wherein the respective charging contact is aligned to one of the two hearing apparatus contact by moving the sliding elements.

22. The charging device as claimed in claim 19, wherein the positioning facility comprising for each of the two charging contacts:
two adjusting screws arranged at a right angles to one another,
wherein the respective charging contact is movable in the first the second directions by the two adjusting screws.

23. A hearing device system, comprising:
an ITE hearing apparatus, comprising:
a faceplate, and
two hearing apparatus contacts in the faceplate; and
a charging device, comprising:
a carrier plate,
two charging contacts each connecting to one of the two hearing apparatus contacts in order to charge the hearing apparatus, and
a positioning facility arranged on the carrier plate and attached to the two charging contact such that each charging contact is movable to one of a plurality of positions in order to align the respective charging contact with the one of the two hearing apparatus contacts.

24. The hearing device system as claimed in claim 23, wherein each of the two charging contacts is a pin which is movable by the positioning facility at right angles to a longitudinal axis of the respective charging contact.

25. The hearing device system as claimed in claim 23, wherein the charging device further comprising:
a cover,
wherein the two charging contacts and the positioning facility are arranged on the cover by way of the carrier plate.

26. The hearing device system as claimed in claim 23, the charging device further comprising:
a metal charging surface,
wherein each of the two charging contacts is movable by the positioning facility on the metal charging surface, and
wherein during a charging process, a charging current flowing from the charging surface into the two charging contacts.

27. The hearing device system as claimed in claim 23, wherein the positioning facility comprising for each of the two charging contacts:
a first sliding element movable in a first direction, and
a second sliding element movable in a second direction at a right angle to the first direction,
wherein the respective charging contact is aligned to one of the two hearing apparatus contacts by moving the sliding elements.

28. The hearing device system as claimed in claim 27, wherein the respective charging contact is arranged at a point of intersection of the first and second sliding elements.

29. The hearing device system as claimed in claim 23, wherein the positioning facility comprising for each of the two charging contacts:
two adjusting screws arranged at a right angles to one another,
wherein the respective charging contact is movable in the first and second directions by the two adjusting screws.
